(19) United States
(12) Patent Application Publication
(10) Pub. No.: US 2023/0311106 A1
(43) Pub. Date: Oct. 5, 2023

(54) PHOTOCATALYST DEVICE, METHOD FOR MANUFACTURING PHOTOCATALYST DEVICE, AND GAS PRODUCTION DEVICE

(71) Applicant: SEIKO EPSON CORPORATION, Tokyo (JP)

(72) Inventor: Hiroaki JIROKU, Suwa-shi (JP)

(73) Assignee: SEIKO EPSON CORPORATION, Tokyo (JP)

(21) Appl. No.: 18/191,886

(22) Filed: Mar. 29, 2023

(30) Foreign Application Priority Data
Mar. 31, 2022 (JP) 2022-059114

(51) Int. Cl. B01J 35/00; B01J 37/02; B01J 19/12

(52) U.S. Cl. CPC B01J 35/0006; B01J 35/004; B01J 35/0033; B01J 37/0228; B01J 37/0244; B01J 19/12; B01J 2219/0892

(57) ABSTRACT

A photocatalyst device that includes a substrate having conductivity, a first photocatalyst layer in contact with the substrate, provided with at least one opening portion, and formed of one of an oxidation catalyst and a reduction catalyst, and a second photocatalyst layer provided at the opening portion and in contact with the substrate, and formed of the other of the oxidation catalyst and the reduction catalyst.

The present application is based on, and claims priority from JP Application Serial Number 2022-059114, filed Mar. 31, 2022, the disclosure of which is hereby incorporated by reference herein in its entirety.

### BACKGROUND

### 1. Technical Field

The present disclosure relates to a photocatalyst device, a method for manufacturing a photocatalyst device, and a gas production device.

### 2. Related Art

A photocatalyst that exhibits a catalytic action when irradiated with light is known.

For example, WO 2006/082801 describes a gas production device in which a semiconductor photocatalyst is used to generate hydrogen by an oxidation-reduction reaction.

As described above, when a desired gas is generated by the oxidation-reduction reaction using the photocatalyst, it is required to increase efficiency of the reaction.

### SUMMARY

An aspect of a photocatalyst device according to the present disclosure includes
a substrate having conductivity,
a first photocatalyst layer in contact with the substrate, provided with at least one opening portion, and formed of one of an oxidation catalyst and a reduction catalyst, and
a second photocatalyst layer provided at the opening portion and in contact with the substrate, and formed of the other of the oxidation catalyst and the reduction catalyst.

An aspect of a method for manufacturing a photocatalyst device according to the present disclosure includes
forming a first photocatalyst layer formed of one of an oxidation catalyst and a reduction catalyst, at a conductive substrate,
forming an opening portion to expose the substrate, at the first photocatalyst layer, and
crystal-growing a second photocatalyst layer formed of the other of the oxidation catalyst and the reduction catalyst, at the exposed substrate, with the first photocatalyst layer as a mask.

An aspect of a gas production device according to the present disclosure includes an aspect of the photocatalyst device.

### BRIEF DESCRIPTION OF THE DRAWINGS

FIG. 1 is a cross-sectional view schematically illustrating a photocatalyst device according to the present exemplary embodiment.

FIG. 2 is a plan view schematically illustrating the photocatalyst device according to the present exemplary embodiment.

FIG. 3 is a flowchart for explaining a method for manufacturing the photocatalyst device according to the present exemplary embodiment.

FIG. 4 is a cross-sectional view schematically illustrating a manufacturing process of the photocatalyst device according to the present exemplary embodiment.

FIG. 5 is a cross-sectional view schematically illustrating a photocatalyst device according to a first modification example of the present exemplary embodiment.

FIG. 6 is a plan view schematically illustrating the photocatalyst device according to the first modification example of the present exemplary embodiment.

FIG. 7 is a cross-sectional view schematically illustrating a photocatalyst device according to a second modification example of the present exemplary embodiment.

FIG. 8 is a plan view schematically illustrating the photocatalyst device according to the second modification example of the present exemplary embodiment.

FIG. 9 is a cross-sectional view schematically illustrating a gas production device according to the present exemplary embodiment.

### DESCRIPTION OF EXEMPLARY EMBODIMENTS

A preferred exemplary embodiment of the present disclosure will be described in detail hereinafter using the figures. Note that, the exemplary embodiment described hereinafter is not intended to unjustly limit the content of the present disclosure as set forth in the claims. In addition, all of the configurations described in the following are not necessarily essential constituent requirements of the present disclosure.

1. Photocatalyst Device

### 1.1. Configuration

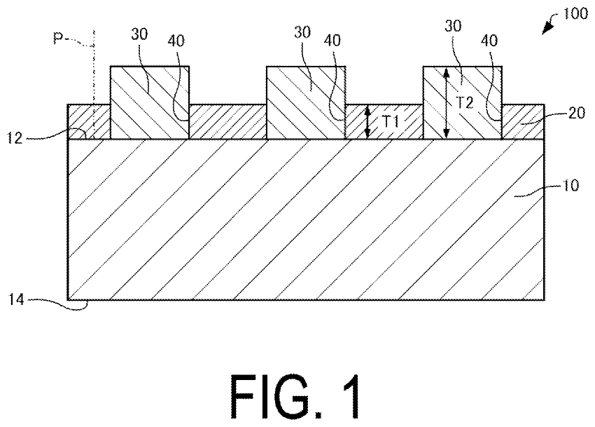

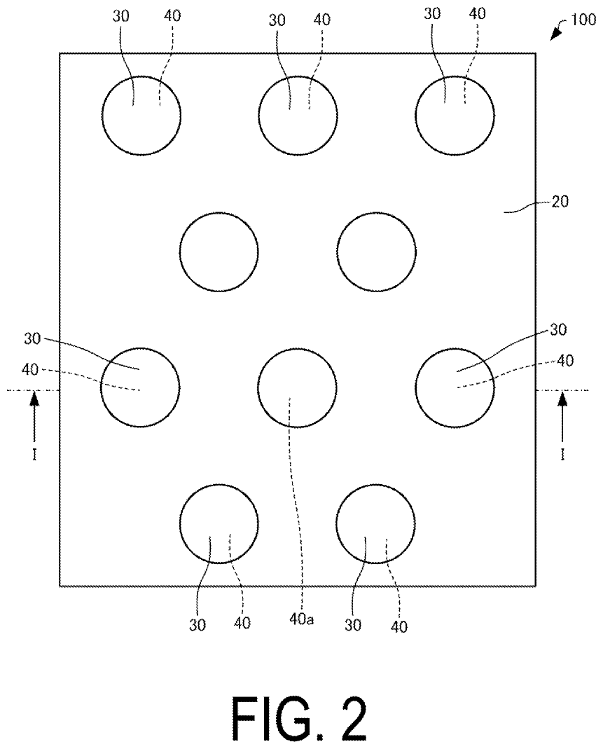

First, a photocatalyst device according to the present exemplary embodiment will be described with reference to the figures. FIG. 1 is a cross-sectional view schematically illustrating a photocatalyst device 100 according to the present exemplary embodiment. FIG. 2 is a plan view schematically illustrating the photocatalyst device 100 according to the present exemplary embodiment. Note that, FIG. 1 is a cross-sectional view taken along a line I-I in FIG. 2.

As illustrated in FIGS. 1 and 2, the photocatalyst device 100 includes a substrate 10, a first photocatalyst layer 20 as a reduction photocatalyst layer, and a second photocatalyst layer 30 as an oxidation photocatalyst layer.

The substrate 10 supports the first photocatalyst layer 20 and the second photocatalyst layer 30. The substrate 10 includes a first main surface 12 and a second main surface 14. In the illustrated example, the first main surface 12 and the second main surface 14 are parallel to each other.

The substrate 10 has conductivity. The substrate 10 is formed of, for example, a semiconductor doped with impurities. The substrate 10 is, for example, a GaN substrate or a Si substrate doped with impurities.

As illustrated in FIG. 1, the first photocatalyst layer 20 is provided above the substrate 10. The first photocatalyst layer 20 is provided at the first main surface 12 of the substrate 10. The first photocatalyst layer 20 is in contact with the substrate 10.

The first photocatalyst layer 20 is the reduction photocatalyst layer formed of a reduction catalyst that promotes a reduction reaction. The reduction catalyst forming the first photocatalyst layer 20 is, for example, a hydrogen-generating photocatalyst that promotes generation of hydrogen (H₂) when irradiated with light.

The first photocatalyst layer 20 is constituted with, for example, a semiconductor layer. The first photocatalyst layer 20 is constituted with, for example, an oxide semiconductor layer. A material of the first photocatalyst layer 20 is, for example, WO₃, SrTiO₃, TiO₂, Fe₂O₃, BiVO₄, ZnO, NiO, Si, CuO, Cu₂O, or CuFeO₂.

At least one opening portion 40 is provided at the first photocatalyst layer 20. The opening portion 40 penetrates the first photocatalyst layer 20 in a perpendicular P direction of the substrate 10. The perpendicular P is a perpendicular of the first main surface 12 of the substrate 10. In the example illustrated in FIG. 2, a planar shape of the opening portion 40 is a circle. The first photocatalyst layer 20 functions as a mask layer for growing the second photocatalyst layer 30.

A diameter of the opening portion 40 provided at the first photocatalyst layer 20 is, for example, from 50 nm and to 500 nm. Note that, the “diameter of the opening portion 40” is a diameter when the planar shape of the opening portion 40 is the circle, and is a diameter of a smallest enclosing circle when the planar shape of the opening portion 40 is a shape other than the circle. For example, the diameter of the opening portion 40, when the planar shape of the opening portion 40 is a polygon, is a diameter of a smallest circle enclosing the polygon, and when the planar shape of the opening portion 40 is an ellipse, is a diameter of a smallest circle enclosing the ellipse.

For example, a plurality of the opening portions 40 are provided at the first photocatalyst layer 20. An interval between the adjacent opening portions 40 is, for example, from 1 nm to 500 nm. The plurality of opening portions 40 are periodically arrayed at a predetermined pitch in a predetermined direction, when viewed from the perpendicular P direction. The plurality of opening portions 40 are arrayed, for example, in a triangular lattice pattern or a square lattice pattern. In the illustrated example, the plurality of opening portions 40 are arrayed in a regular triangular lattice pattern.

Note that, the “pitch of the opening portions 40” is a distance between centers of the opening portions 40 adjacent to each other in a predetermined direction. The “center of the opening portion 40”, when the planar shape of the opening portion 40 is the circle, is a center of the circle, and when the planar shape of the opening portion 40 is a shape other than the circle, is a center of the smallest enclosing circle. For example, the center of the opening portion 40, when the planar shape of the opening portion 40 is a polygon, is a center of a smallest circle enclosing the polygon, and when the planar shape of the opening portion 40 is an ellipse, is a center of a smallest circle including the ellipse.

As illustrated in FIG. 1, the second photocatalyst layer 30 is provided above the substrate 10. The second photocatalyst layer 30 is provided at the first main surface 12 of the substrate 10. The second photocatalyst layer 30 is in contact with the substrate 10. A thickness T1 of the first photocatalyst layer 20 and a thickness T2 of the second photocatalyst layer 30 are different from each other. In the illustrated example, the thickness T1 is less than the thickness T2. The “thickness” refers to a size in the perpendicular P direction.

The second photocatalyst layer 30 is provided at the opening portion 40. The second photocatalyst layer 30 is in contact with the first photocatalyst layer 20 that defines an inner surface of the opening portion 40. In the illustrated example, the second photocatalyst layer 30 is provided at each of the plurality of opening portions 40. The plurality of second photocatalyst layers 30 are separated from each other.

The second photocatalyst layer 30 has, for example, a columnar shape protruding from the substrate 10 in the perpendicular P direction. The second photocatalyst layer 30 is also called, for example, a nanocolumn, a nanowire, a nanorod, or a nanopillar. A planar shape of the second photocatalyst layer 30 is, for example, a polygon such as a regular hexagon, or a circle. In the example illustrated in FIG. 2, the planar shape of the second photocatalyst layer 30 is a circle.

The second photocatalyst layer 30 is an oxidation photocatalyst layer formed of an oxidation catalyst that promotes an oxidation reaction. The oxidation catalyst forming the second photocatalyst layer 30 is, for example, an oxygen-generating photocatalyst that promotes generation of oxygen (O₂) when irradiated with light.

The second photocatalyst layer 30 is constituted with, for example, a semiconductor layer. The second photocatalyst layer 30 may be single crystalline. The second photocatalyst layer 30 is constituted with, for example, a group III-V compound semiconductor layer. A material of the second photocatalyst layer 30 is, for example, GaN, InGaN, AlGaN, or AlInGaN.

When the second photocatalyst layer 30 contains In, potential energy of a valence band and a conduction band of the second photocatalyst layer 30 can be changed, by preparing In composition. The same applies to a case where the second photocatalyst layer 30 contains Al.

Note that, although not illustrated, a support substrate for supporting the substrate 10 may be provided at the second main surface 14 of the substrate 10. The substrate 10 may be formed by being crystal-grown from the support substrate. The support substrate is, for example, a semiconductor substrate, a sapphire substrate, or the like. Further, the first photocatalyst layer 20 as the reduction photocatalyst layer may be constituted with a group III-V compound semiconductor layer, and the second photocatalyst layer 30 as the oxidation photocatalyst layer may be constituted with an oxide semiconductor layer.

1.2. Operation

Hereinafter, an example will be described in which, in the photocatalyst device 100, the first photocatalyst layer 20 is formed of a hydrogen-generating photocatalyst, the second photocatalyst layer 30 is formed of an oxygen-generating photocatalyst, and water (H₂O) is decomposed to generate hydrogen.

When the second photocatalyst layer 30 is irradiated with sunlight in a state where the photocatalyst device 100 is immersed in water, the second photocatalyst layer 30 absorbs the sunlight and electrons are excited. The second photocatalyst layer 30 absorbs, for example, visible light of the sunlight. Holes are generated by the excitation of electrons in the second photocatalyst layer 30. By the generated holes, the second photocatalyst layer 30 promotes an oxidation reaction of oxidizing water to generate oxygen.

When the first photocatalyst layer 20 is irradiated with sunlight in a state where the photocatalyst device 100 is immersed in water, the first photocatalyst layer 20 absorbs the sunlight and electrons are excited. The first photocatalyst layer 20 absorbs, for example, visible light of the sunlight. Holes are generated by the excitation of electrons in the first photocatalyst layer 20. The holes generated in the first photocatalyst layer 20 are recombined with the excited electrons in the second photocatalyst layer 30 in the conductive substrate 10. Then, with the electrons excited in the first photocatalyst layer 20, the first photocatalyst layer 20 promotes a reduction reaction of reducing hydrogen ions to generate hydrogen.

The photocatalyst device 100 can constitute a closed circuit as described above. The photocatalyst device 100 is a so-called Z scheme type photocatalyst device that performs photoexcitation in two stages.

Note that, the recombination of the holes generated in the first photocatalyst layer 20 and the electrons excited in the second photocatalyst layer 30 is also performed at a contact portion between the first photocatalyst layer 20 and the second photocatalyst layer 30.

Further, although not illustrated, a promoter that promotes a reaction with water may be attached to at least one of a front surface of the first photocatalyst layer 20 and a front surface of the second photocatalyst layer 30.

1.3. Operation and Effect

The photocatalyst device 100 includes the substrate 10 having conductivity, the first photocatalyst layer 20 in contact with the substrate 10, provided with the at least one opening portion 40, and formed of the reduction catalyst, and the second photocatalyst layer 30 provided at the opening portion 40, in contact with the substrate 10, and formed of the oxidation catalyst.

Therefore, in the photocatalyst device 100, for example, the holes generated in the first photocatalyst layer 20, and the electrons excited in the second photocatalyst layer 30 can be recombined, in the substrate 10. As a result, reaction efficiency can be increased, as compared with a case where the substrate is insulating. As a result, solar to hydrogen conversion efficiency (STH) can be increased.

Further, in the photocatalyst device 100, the second photocatalyst layer 30 as the oxidation catalyst is provided at the opening portion 40 provided at the first photocatalyst layer 20 as the reduction catalyst. Therefore, in the photocatalyst device 100, it is easy to control relative positions of the oxidation catalyst and the reduction catalyst as compared with a case where the oxidation catalyst and the reduction catalyst are powdery.

Furthermore, in the photocatalyst device 100, as described above, the photoexcitation is performed in the two stages using the two types of photocatalysts. Therefore, in the photocatalyst device 100, since a material in which a band gap that absorbs visible light is small can be used for the photocatalyst layers 20 and 30, the STH can be increased. For example, when photoexcitation is performed in one stage using one type of photocatalyst, it is necessary to use a photocatalyst made of a material having a large band gap. Therefore, electrons are not excited by visible light, and are excited only by, for example, ultraviolet light, in some cases, and the STH decreases.

In the photocatalyst device 100, the thickness T1 of the first photocatalyst layer 20 and the thickness T2 of the second photocatalyst layer 30 are different from each other. Therefore, in the photocatalytic device 100, an average refraction index in a direction orthogonal to the perpendicular P direction at a front surface of the photocatalyst device 100 opposite to the substrate 10 can be decreased, as compared with a case where the thickness T1 and the thickness T2 are the same. Accordingly, it is possible to reduce light reflected by the front surface of the photocatalyst device 100 opposite to the substrate 10. In addition, when sunlight is radiated from a direction inclined with respect to the perpendicular P, it is possible to increase a region irradiated with the sunlight, as compared with the case where the thicknesses T1 and T2 are the same.

In the photocatalyst device 100, the plurality of opening portions 40 are provided, the plurality of opening portions 40 are periodically arrayed when viewed from the perpendicular P direction of the substrate 10, and the second photocatalyst layer 30 is provided at each of the plurality of opening portions 40. Therefore, in the photocatalyst device 100, the plurality of second photocatalyst layers 30 can be uniformly disposed, with respect to the first photocatalyst layer 20, as compared with a case where the plurality of opening portions are not periodically arrayed. Thereby, for example, the recombination of the holes generated in the first photocatalyst layer 20 and the electrons excited in the second photocatalyst layer 30 can be efficiently performed.

For example, by arraying the plurality of opening portions 40 in a regular triangular lattice shape when viewed from the perpendicular P direction, six of the opening portions 40 having the same interval can be provided with respect to an opening portion 40a among the plurality of opening portions 40. Therefore, the holes generated in the first photocatalyst layer 20 and the electrons excited in the second photocatalyst layer 30 can be recombined more efficiently, by arraying the plurality of opening portions 40 in the regular triangular lattice shape.

In the photocatalyst device 100, the substrate 10, the first photocatalyst layer 20, and the second photocatalyst layer 30 are made of a semiconductor. Therefore, the photocatalyst device 100 can be manufactured by a semiconductor process.

In the photocatalyst device 100, the oxidation catalyst is the oxygen-generating photocatalyst, and the reduction catalyst is the hydrogen-generating photocatalyst. Therefore, in the photocatalyst device 100, hydrogen can be generated.

2. Method for Manufacturing Photocatalyst Device

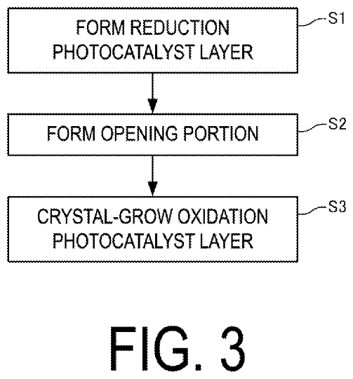

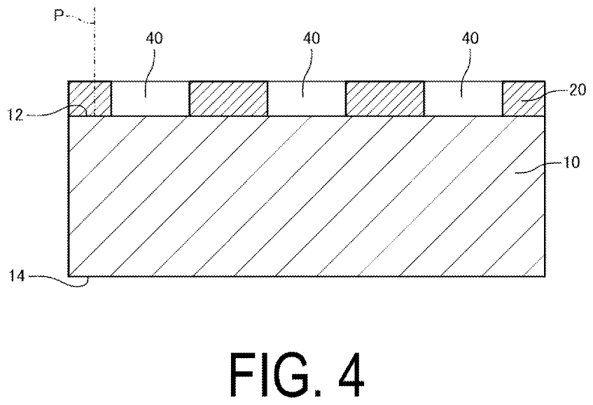

Next, a method for manufacturing the photocatalyst device 100 according to the present exemplary embodiment will be described with reference to the figures. FIG. 3 is a flowchart for explaining the method for manufacturing the photocatalyst device 100 according to the present exemplary embodiment. FIG. 4 is a cross-sectional view schematically illustrating a manufacturing process of the photocatalyst device 100 according to the present exemplary embodiment.

As illustrated in FIGS. 3 and 4, the first photocatalyst layer 20 is formed above the substrate 10 (step S1). The first photocatalyst layer 20 is formed by, for example, an electron beam deposition method, a sputtering method, a chemical vapor deposition (CVD) method, or the like.

Next, the first photocatalyst layer 20 is patterned to form the opening portion 40 that exposes the substrate 10 (step S2). The patterning is performed by, for example, electron beam lithography and etching, photolithography and etching, or the like.

As illustrated in FIG. 1, the second photocatalyst layer 30 is crystal-grown above the exposed substrate 10, with the first photocatalyst layer 20 as a mask (step S3). The crystal growth is performed by, for example, epitaxial growth. Examples of the method for the epitaxial growth include a metal organic chemical vapor deposition (MOCVD) method and a molecular beam epitaxy (MBE) method. The second photocatalyst layer 30 having few crystal defects can be formed by the epitaxial growth.

The photocatalyst device 100 can be manufactured by the process described above.

The method for manufacturing the photocatalyst device 100 includes the forming the first photocatalyst layer 20 formed of the reduction catalyst at the conductive substrate 10, the forming the opening portion 40 to expose the substrate 10, at the first photocatalyst layer 20, and the crystal-growing the second photocatalyst layer 30 formed of the oxidation catalyst, at the exposed substrate 10, with the first photocatalyst layer 20 as the mask.

Therefore, with the method for manufacturing the photocatalyst device 100, it is possible to manufacture the photocatalyst device 100 capable of increasing efficiency of an oxidation-reduction reaction of water. Further, with the method for manufacturing the photocatalyst device 100, the process can be shortened, as compared with a case where a mask layer is separately formed without the first photocatalyst layer 20 as the mask. Furthermore, in the method for manufacturing the photocatalyst device 100, the second photocatalyst layer 30 is crystal-grown with the first photocatalyst layer 20 as the mask, thus accuracy of a position of the second photocatalyst layer 30 with respect to the first photocatalyst layer 20 can be improved.

3. Modification Examples of Photocatalyst Device

### 3.1. First Modification Example

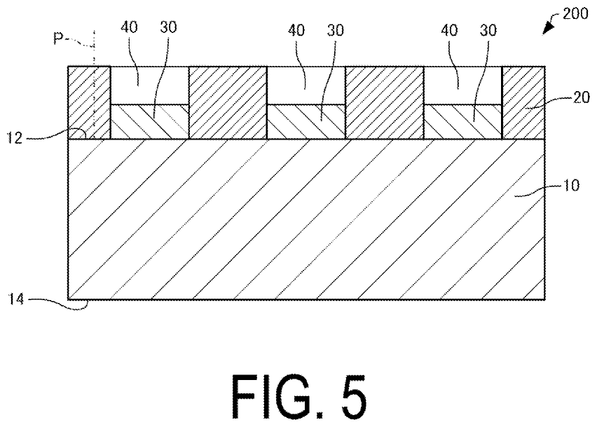

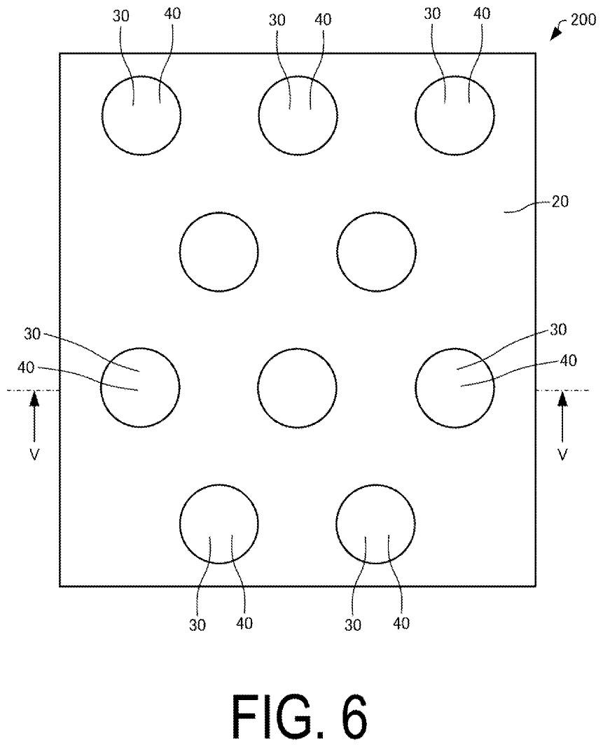

Next, a photocatalyst device according to a first modification example of the present exemplary embodiment will be described with reference to the figures. FIG. 5 is a cross-sectional view schematically illustrating a photocatalyst device 200 according to the first modification example of the present exemplary embodiment. FIG. 6 is a plan view schematically illustrating the photocatalyst device 200 according to the first modification example of the present exemplary embodiment. Note that, FIG. 5 is a cross-sectional view taken along a line V-V in FIG. 6.

Hereinafter, in the photocatalyst device 200 according to the first modification example of the present exemplary embodiment, members having the same functions as those of the constituent members of the photocatalyst device 100 according to the present exemplary embodiment described above are denoted by the same reference numerals, and detailed description thereof is omitted. This is the same in a photocatalyst device according to a second modification example of the present exemplary embodiment described later.

As illustrated in FIGS. 1 and 2, the photocatalyst device 100 described above includes the first photocatalyst layer 20 as the reduction photocatalyst layer, and the second photocatalyst layer 30 as the oxidation photocatalyst layer.

On the other hand, as illustrated in FIGS. 5 and 6, the photocatalyst device 200 includes the first photocatalyst layer 20 as an oxidation photocatalyst layer and the second photocatalyst layer 30 as a reduction photocatalyst layer. The first photocatalyst layer 20 is constituted with, for example, a group III-V compound semiconductor layer. Further, the second photocatalyst layer 30 is constituted with, for example, an oxide semiconductor layer. Alternatively, not limited thereto, the first photocatalyst layer 20 as an oxidation photocatalyst may be constituted with an oxide semiconductor layer, and the second photocatalyst layer 30 as a reduction photocatalyst may be constituted with a group III-V compound semiconductor layer.

3.2. Second Modification Example

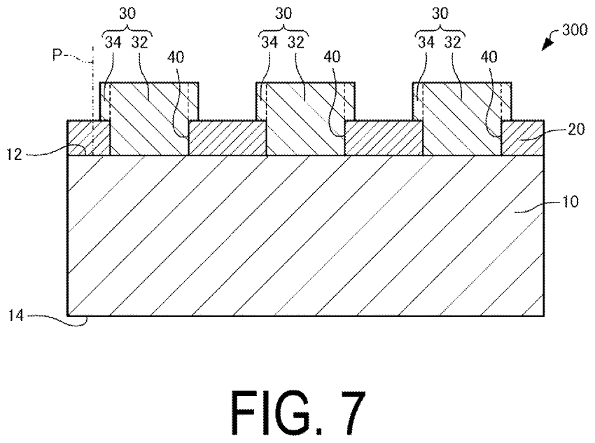

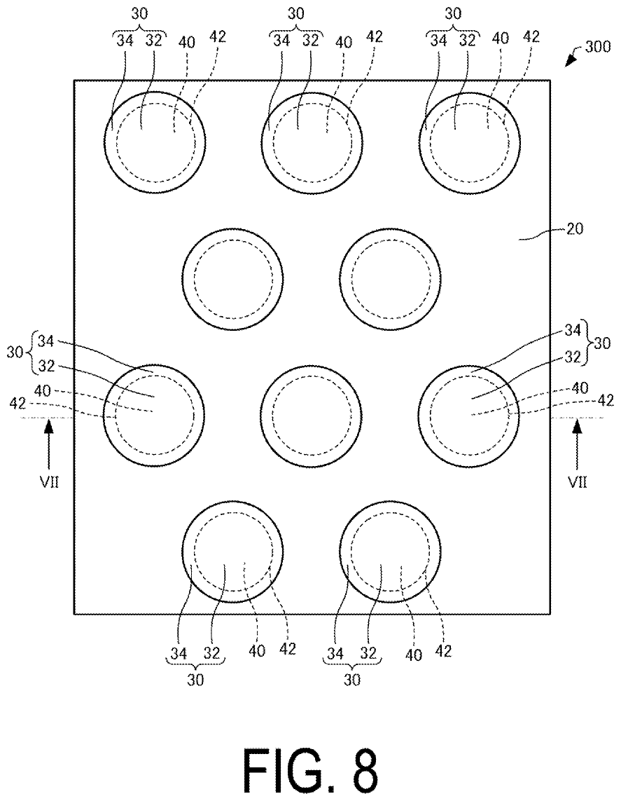

Next, the photocatalyst device according to the second modification example of the present exemplary embodiment will be described with reference to the figures. FIG. 7 is a cross-sectional view schematically illustrating a photocatalyst device 300 according to the second modification example of the present exemplary embodiment. FIG. 8 is a plan view schematically illustrating the photocatalyst device 300 according to the second modification example of the present exemplary embodiment. Note that, FIG. 7 is a cross-sectional view taken along a line VII-VII in FIG. 8.

In the above-described photocatalyst device 100, as illustrated in FIGS. 1 and 2, a size of the second photocatalyst layer 30 is the same as a size of the opening portion 40 when viewed from the perpendicular P direction.

On the other hand, in the photocatalyst device 300, as illustrated in FIGS. 7 and 8, the size of the second photocatalyst layer 30 is larger than the size of the opening portion 40 when viewed from the perpendicular P direction.

Further, the second photocatalyst layer 30 extends outward from an outer edge 42 of the opening portion 40, when viewed from the perpendicular P direction. The second photocatalyst layer 30 includes a first portion 32 overlapping the opening portion 40, and a second portion 34 extending outward from the outer edge 42 of the opening portion 40, when viewed from the perpendicular P direction.

The first portion 32 is provided at the opening portion 40. The second portion 34 does not overlap the opening portion 40, when viewed from the perpendicular P direction. The second portion 34 is in contact with the first portion 32. The second portion 34 is in contact with the first photocatalyst layer 20. The first photocatalyst layer 20 is located between the second portion 34 and the substrate 10.

For example, when epitaxially growing the second photocatalyst layer 30, the second photocatalyst layer 30 having the second portion 34 can be formed by laterally growing the second photocatalyst layer 30.

Further, in the photocatalyst device 300, the second photocatalyst layer 30 extends outward from the outer edge 42 of the opening portion 40, when viewed from the perpendicular P direction of the substrate 10, and the second portion 34 extending outward from the outer edge 42 of the second photocatalyst layer 30 is in contact with the first photocatalyst layer 20. Therefore, in the photocatalyst device 300, a contact surface between the first photocatalyst layer 20 and the second photocatalyst layer 30 can be increased, as compared with a case where the oxidation photocatalyst layer does not include the second portion. Thus, recombination of holes generated in the first photocatalyst layer 20, and electrons excited in the second photocatalyst layer 30, at a contact portion between the first photocatalyst layer 20 and the second photocatalyst layer 30, can be promoted.

4. Gas Production Device

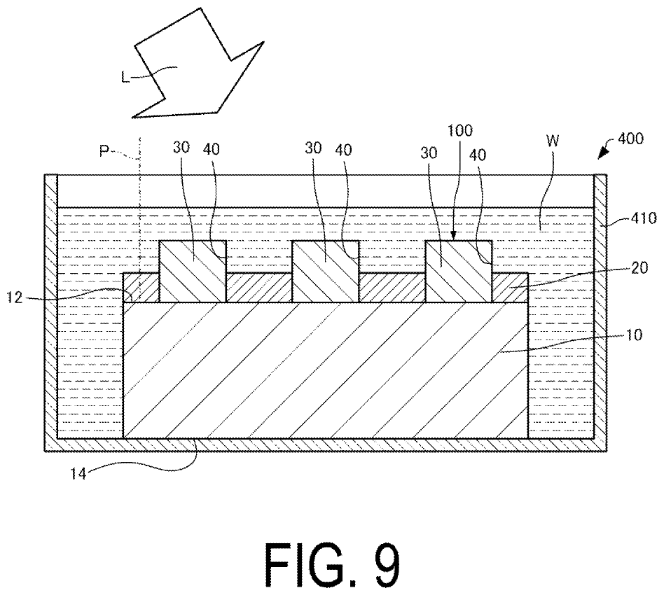

Next, a gas production device according to the present exemplary embodiment will be described with reference to the figures. FIG. 9 is a cross-sectional view schematically illustrating a gas production device 400 according to the present exemplary embodiment.

As illustrated in FIG. 9, the gas production device 400 includes, for example, the photocatalyst device 100 and a water tank 410.

The photocatalyst device 100 is provided in a water tank 410. The photocatalyst device 100 is immersed in water W. In the illustrated example, the second main surface 14 of the photocatalyst device 100 is in contact with a bottom surface of the water tank 410.

When the photocatalyst device 100 is irradiated with sunlight L, the gas production device 400 produces a predetermined gas. As described above, when the first photocatalyst layer 20 is formed of the hydrogen-generating photocatalyst, and the second photocatalyst layer 30 is formed of the oxygen-generating photocatalyst, the gas production device 400 reduces the water W to produce hydrogen. Further, the gas production device 400 oxidizes the water W to produce oxygen.

Note that, the photocatalyst device according to the present exemplary embodiment is not limited to the example in which water is reduced, and for example, may be used for reduction of carbon dioxide (CO₂), by appropriately changing the materials forming the reduction photocatalyst layer and the oxidation photocatalyst layer by applying a known technique.

The above-described exemplary embodiment and modification examples are merely examples, and the present disclosure is not limited thereto. For example, a known technique may be applied to the material of the first photocatalyst layer 20 or the second photocatalyst layer 30, and the material forming the reduction photocatalyst layer or the oxidation photocatalyst layer may be appropriately selected and used. As the material of the first photocatalyst layer 20 or the second photocatalyst layer 30, an oxide semiconductor made of WO₃, SrTiO₃, TiO₂, Fe₂O₃, BiVO₄, ZnO, NiO, Si, CuO, Cu₂O, CuFeO₂, or the like, a group III-V compound semiconductor layer made of GaN, InGaN, AlGaN, AlInGaN, or the like, may be used. Furthermore, for example, it is also possible to appropriately combine each exemplary embodiment and each modification example.

The present disclosure includes substantially the same configuration as the configuration described in the exemplary embodiment, for example, a configuration having the same function, method, and result, or a configuration having the same object and effect. In addition, the present disclosure includes a configuration in which non-essential parts of the configurations described in the exemplary embodiment are replaced. In addition, the present disclosure includes a configuration that achieves the same operation and effect as those of the configuration described in the exemplary embodiment or a configuration that can achieve the same object. In addition, the present disclosure includes a configuration in which a known technique is added to the configuration described in the exemplary embodiment.

The following contents are derived from the above-described exemplary embodiment and modification examples.

An aspect of a photocatalyst device includes
a substrate having conductivity,
a first photocatalyst layer in contact with the substrate, provided with at least one opening portion, and formed of one of an oxidation catalyst and a reduction catalyst, and
a second photocatalyst layer provided at the opening portion and in contact with the substrate, and formed of the other of the oxidation catalyst and the reduction catalyst.

According to the photocatalyst device, reaction efficiency can be improved.

In an aspect of the photocatalyst device,
a thickness of the first photocatalyst layer and a thickness of the second photocatalyst layer may be different from each other.

According to the photocatalyst device, it is possible to reduce light reflected by a front surface of the photocatalyst device opposite to the substrate.

In an aspect of the photocatalyst device,
a plurality of the opening portions may be provided,
the plurality of opening portions may be periodically arrayed, when viewed from a perpendicular direction of the substrate, and
the second photocatalyst layer may be provided at each of the plurality of opening portions.

According to the photocatalyst device, the plurality of second photocatalyst layers can be uniformly disposed, with respect to the first photocatalyst layer.

In an aspect of the photocatalyst device,
the second photocatalyst layer, further, may extend outward from an outer edge of the opening portion, when viewed from the perpendicular direction of the substrate, and
a portion of the second photocatalyst layer extending outward from the outer edge may be in contact with the first photocatalyst layer.

According to the photocatalyst device, a contact surface between the first photocatalyst layer and the second photocatalyst layer can be increased.

In an aspect of the photocatalyst device,
the substrate, the first photocatalyst layer, and the second photocatalyst layer may be formed of a semiconductor.

The photocatalyst device can be manufactured by a semiconductor process.

In an aspect of the photocatalyst device,
the oxidation catalyst may be an oxygen-generating photocatalyst, and
the reduction catalyst may be a hydrogen-generating photocatalyst.

According to the photocatalyst device, hydrogen can be generated.

An aspect of a method for manufacturing a photocatalyst device includes
forming a first photocatalyst layer formed of one of an oxidation catalyst and a reduction catalyst, at a conductive substrate,
forming an opening portion to expose the substrate, at the first photocatalyst layer, and
crystal-growing a second photocatalyst layer formed of the other of the oxidation catalyst and the reduction catalyst, at the exposed substrate, with the first photocatalyst layer as a mask.

According to the method for manufacturing the photocatalyst device, it is possible to manufacture the photocatalyst device capable of increasing reaction efficiency.

An aspect of a gas production device includes
an aspect of the photocatalyst device.

What is claimed is:

1. A photocatalyst device, comprising:
a substrate having conductivity;
a first photocatalyst layer in contact with the substrate, provided with at least one opening portion, and formed of one of an oxidation catalyst and a reduction catalyst; and
a second photocatalyst layer provided at the opening portion and in contact with the substrate, and formed of the other of the oxidation catalyst and the reduction catalyst.

2. The photocatalyst device according to claim 1, wherein
a thickness of the first photocatalyst layer and a thickness of the second photocatalyst layer are different.

3. The photocatalyst device according to claim 1, wherein
a plurality of the opening portions are provided,
the plurality of opening portions are periodically arrayed when viewed from a perpendicular direction of the substrate, and
the second photocatalyst layer is provided at each of the plurality of opening portions.

4. The photocatalyst device according to claim 1, wherein
the second photocatalyst layer, further, extends outward from an outer edge of the opening portion when viewed from a perpendicular direction of the substrate, and
a portion of the second photocatalyst layer extending outward from the outer edge is in contact with the first photocatalyst layer.

5. The photocatalyst device according to claim 1, wherein
each of the substrate, the first photocatalyst layer, and the second photocatalyst layer is formed of a semiconductor.

6. The photocatalyst device according to claim 1, wherein
the oxidation catalyst is an oxygen-generating photocatalyst, and
the reduction catalyst is a hydrogen-generating photocatalyst.

7. A method for manufacturing a photocatalyst device, comprising:
forming a first photocatalyst layer formed of one of an oxidation catalyst and a reduction catalyst, at a conductive substrate,
forming an opening portion to expose the substrate, at the first photocatalyst layer, and
crystal-growing a second photocatalyst layer formed of the other of the oxidation catalyst and the reduction catalyst, at the exposed substrate, with the first photocatalyst layer as a mask.

8. A gas production device comprising the photocatalyst device according to claim 1.
